(19) United States
(12) Patent Application Publication
(10) Pub. No.: US 2007/0203843 A1
(43) Pub. Date: Aug. 30, 2007

(54) SYSTEM AND METHOD FOR EFFICIENT ENCRYPTION AND DECRYPTION OF DRM RIGHTS OBJECTS

(76) Inventors: Lauri Tarkkala, Espoo (FI); Nadarajah Asokan, Espoo (FI)

Correspondence Address: MORGAN & FINNEGAN, L.L.P., 3 WORLD FINANCIAL CENTER, NEW YORK, NY, 10281-2101, US

(21) Appl. No.: 11/382,125

(22) Filed: May 8, 2006

Related U.S. Application Data
(60) Provisional application No. 60/679,364, filed on May 9, 2005.

(51) Int. Cl. H04L 9/00

(52) U.S. Cl. 705/54

(57) ABSTRACT

A content encryption/decryption system is disclosed that provides for the use of multiple DRM rights objects. The disclosed system also provides for use in non-connected, connected and mixed mode transmission models.

### RELATED APPLICATION DATA

This application claims priority under 35 U.S.C. § 119 to U.S. Provisional Patent Application Ser. No. 60/679,364 entitled “SYSTEM AND METHOD FOR EFFICIENT ENCRYPTION AND DECRYPTION OF DRM RIGHTS OBJECTS” filed on May 9, 2005, and incorporated herein by reference.

### FIELD OF INVENTION

The present invention relates generally to the field of security and cryptography. This invention more specifically relates to efficient and secure content encryption and decryption. In particular, the encryption of content keys such that a set of two or more rights objects is required to decrypt a content key.

### BACKGROUND OF THE INVENTION

In digital rights management systems, content is encrypted prior to transmission to avoid the unauthorized use, duplication and transmission of the content. In order to allow flexibility in the way content is distributed, right objects are used to define how content is allowed to be used. For example, a rights object might define the time period during which the receiver may use the content. Typically, the rights object will contain and protect the keys used to decrypt the provided content. Authorized receivers accessing the protected content have hardware and/or software to decrypt the protected keys and use them in accordance with the rules of the rights object. To ensure that the rights object's content usage rules are followed, the decryption hardware and/or software is designed to provide some protection against attempts to defeat the security system. The level of security provided by the system is generally chosen as a design decision based on a number of factors, such as the cost of the system and the value of the content.

### SUMMARY OF THE INVENTION

One aspect of the disclosed system provides for the encryption of a content encryption key using multiple digital rights objects, which are essentially cryptographic service keys residing in separate trusted processing agents on the receiving device. A random seed value is applied to each digital rights object. The outputs of these digital rights objects are combined to form the content encryption key through a mix function. The random seed value can be transmitted to the content receivers.

In a further aspect of the disclosed system, the content encryption key is encrypted using more than one set of multiple digital rights objects. For the first set, the seed or the content encryption key may be chosen randomly. For the remaining sets, the same seed is applied to each digital rights object in that set. The outputs of these digital rights objects in a given set are combined with the previously determined content encryption key through a mix function. For each set, the result of the mix function is also transmitted to the content receivers, in addition to the common seed value, and the descriptions of the composition of each allowed set, identifying which digital rights objects constitute that set.

In a further aspect of the disclosed system content encryption keys can be secured using a process that enables use in a non-connected mode. A random service key is generated and used to encrypt the content key. A device key is retrieved, or generated, and used to encrypt the service key. The encrypted service key is packaged into a broadcast rights object and transmitted to the users. The encrypted content key is also transmitted to the users. The users can recreate the device key and thereby recover the content key through decrypting the encrypted service key and using the service key to decrypt the content key.

In a further aspect of the disclosed system, service keys of each digital rights object required are sent to the client device of authorized users. The service key may be sent in the form of a digital rights object using a standard DRM scheme like OMA DRMv2 Rights Object, or a broadcast rights object in a suitable broadcast encryption scheme. Alternately, the service key may be agreed between the client device and the service provider using some external key agreement procedure like the Generic Bootstrapping Architecture proposal from the 3^{rd} Generation Partnership Project. (http://www.3gpp.org/ftp/Specs/html-info/24109.htm).

In a further aspect of the present invention a connected mode encryption system provides for encryption of a content key using digital rights systems. A random seed value is created and processed by three or more digital rights systems. The outputs of the digital rights systems are combined through the use of two or more mix functions such that at least one of the digital rights management system's outputs are applied to both mix functions. The result of the mix functions are independently used to encrypt the content key thereby creating two or more encrypted versions of the content key. The random seed value and the encrypted content keys are transmitted to the receivers. A receiver can decrypt a particular encrypted content key if it contains the digital rights management systems used to encrypt the content key.

In a further aspect of the present invention, the result of the mix function in each set is used as a key to encrypt the content protection key. For each set, the resulting encrypted content encryption key is transmitted to the content receivers, in addition to the common seed value, and the descriptions of the composition of each allowed set, identifying which digital rights objects constitute that set.

### BRIEF DESCRIPTION OF THE FIGURES

FIG. 1 is an exemplary content distribution system in the context of the disclosed systems and methods.

FIG. 2 shows a first exemplary encryption system.

FIG. 3 shows a first exemplary decryption system to reverse the encryption of FIG. 2.

FIG. 4 shows a second exemplary encryption system.

FIG. 5 shows a second exemplary decryption system to decrypt the connection mode encryption disclosed in FIG. 4.

### DETAILED DESCRIPTION OF THE INVENTION

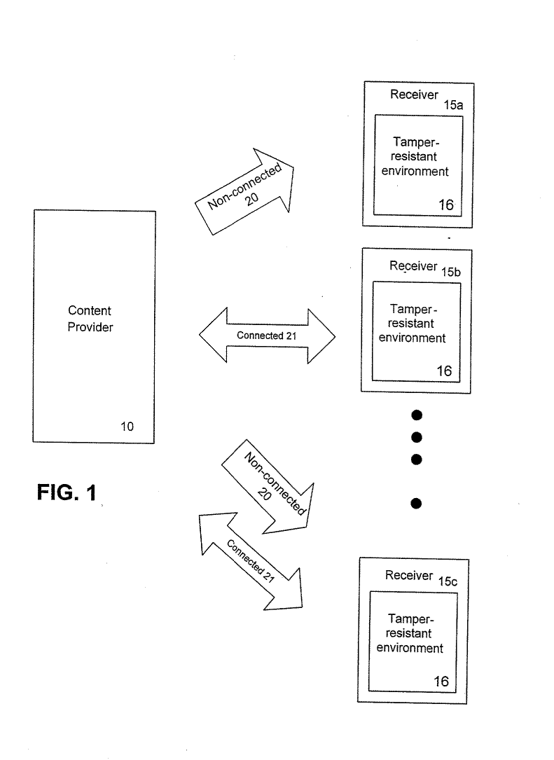

In a content delivery system, as shown in FIG. 1, a content provider 10 transmits content to one or more receivers 15 via one or more transmission mediums. One example of content compatible with the system is television broadcasts sent via over the air transmission, cable, digital video broadcast (DVB), satellite, or internet protocol networks. Other multimedia delivery systems include Digital Multimedia Broadcasting (DMB) and MediaFLO™. Of course, numerous other types of content and transmission mediums would also fit this content delivery model and could take advantage of the disclosed invention. Other examples of content types that could be distributed via this model include audio, text, video games or interactive media. Other examples of suitable transmission mediums include radio broadcast, cellular, Bluetooth, IEEE 802.11x, mesh networks and wired/optical WANs or LAN.

Content providers often provide their users choice among a variety of services. This allows the users to tailor the services they receive to suit their individual needs. In the context of television services, for example, users can choose among premium channels, pay-per-view events and on-demand programming. To facilitate this variety, content providers typically encrypt some or all of their content and only allow authorized receivers to decrypt content corresponding to the services the user purchased.

Consistent with the encryption system of FIG. 1, the content providers 10 will employ hardware and software to encrypt at least some of the transmitted content and receivers 15 will have hardware and software to securely decrypt the content. Of course, the specific operations of the content provider could be split up among a number of entities in a variety of ways. The receivers 15 can be embodied in a wide variety of devices, for example, a television set top box, a mobile terminal or a general-purpose computer. To maintain the security of the encryption scheme, the receivers' hardware and/or software will include a tamper-resistant environment 16 that contains the information and logic required to participate in the encryption system. The tamper-resistant environment 16 helps to ensure that users attempting to defeat the encryption system do not have access to the system's secrets. The tamper-resistant environment 16 can be embodied via any of the systems and methods known in the art.

Management of the encryption/decryption system, however, raises a number of difficulties. The management and distribution of the secret keys and algorithms used to practice the system raises a number of issues. One particular problem is that cost efficient tamper resistant systems, i.e. DRM engines, might be defeated by people looking to circumvent the content protection. If the system's content protection scheme is based solely on one type of DRM engine, its circumvention would release all the protected content. Accordingly, it would be more advantageous to distribute the required decryption keys in a set of multiple rights object, preferably employing different DRM schemes for each rights object. This would provide additional security because an attacker would have to defeat each the DRM scheme for each rights object. The more DRM systems used, the more difficult it would be to defeat the system and the more secure the system would be.

Another advantageous feature of an encryption/decryption system is compatibility with non-connected, connected and mixed transmission modes. As shown in FIG. 1, content provider 10 might communicate with a particular device according to its capabilities or the most suitable transmission means of the content. For example, the content provider might transmit content to a receiver 15a via an unconnected mode 20, such as a one-way only broadcast. The content might also transmit content to another user 15b via a connected mode 21, such as a two-way network communication. A mixed mode device 15c can receive content via either the connected mode or non-connected mode.

The disclosed systems and methods provide for the efficient and secure generation and distribution of the keys required to encrypt and decrypt content such that multiple rights objects are required for the content's decryption. The disclosed systems and methods further allow the content provider to generate rights objects that are compatible with non-connected, connected and mixed mode transmission models.

Additional advantageous features available with the disclosed systems and methods include predictable key-derivation time, low computational overhead and minimal additional bandwidth requirements. The disclosed systems and methods can also be used with randomly chosen content decryption key systems—such as a service protection system for unidirectional broadcast of DVB-Ht to non-connected devices. The disclosed systems and methods can also be used with any arbitrary DRM scheme—including OMA DRMv2.

In the exemplary disclosed systems and methods, protected content P is encrypted with a content encryption key labeled TEK. TEK is a randomly chosen value generated by the content provider. The encrypted version of content P is labeled C, such that C=E_TEK(P). The notation E_TEK(P) and E_{TEK}(P) signify object P encrypted with key TEK. Consistent notation is used throughout with D_signifying decryption. Accordingly, P=D_TEK(C)=D_{TEK}(C). The particular encryption algorithms used are not important to the disclosed system. Examples of suitable algorithms include AES-WRAP and, AES or 3DES in CBC mode. Other suitable algorithms are known in the art and additional suitable algorithms will likely be created in the future.

TEK itself is encrypted to secure the encrypted content C. The system uses rights objects to define the allowable decryption of TEK. Adherence to the rules set forth by the rights objects ensures that the decryption of encrypted content C is performed only in accordance with the rules of the system.

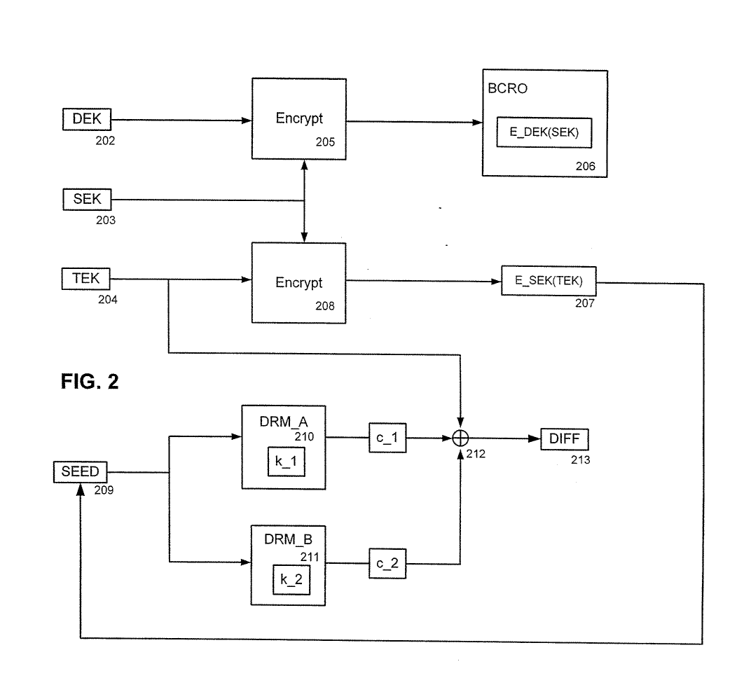

A first exemplary embodiment, is disclosed for non-connected mode, connected mode and mixed mode transmission. Encryption according to the first exemplary embodiment is shown in FIG. 2. FIG. 2 discloses the encryption of TEK and the use of the associated rights objects. FIG. 2 demonstrates two TEK encryption schemes one suitable for non-connected mode devices, the other suitable for connected mode devices. Of course either mode could be independently applicable to mixed mode devices.

For a non-connected mode, the content provider generates or retrieves a device key DEK 202 and a service key SEK 203. Non-connected mode devices contain or can independently generate device key DEK 202. TEK 204 is encrypted 208 with SEK 203 to generate E_SEK(TEK) 207. SEK 203 is encrypted 205 with DEK 202 to generate E_DEK(SEK), which is inserted into broadcast rights object (BCRO) 206. BCRO 206 and E_SEK(TEK) are broadcast to non-connected receivers. As noted above, the encryptions performed at 205 and 208 are compatible with numerous encryption algorithms, such as for example AES-CBC.

For connected mode, the content provider starts with a random seed value 209, which as shown in FIG. 2 could optionally be E_SEK(TEK). If there is only one set of allowed digital rights objects, then SEED could be chosen randomly. If TEK is predetermined (e.g., either because there are unconnected devices that need the same TEK, or because content is already encrypted before the set of allowed digital rights objects are known), then SEED is E_SEK(TEK). The seed value 209 is operated on by two DRM systems in accordance with rights objects of DRM_A 210 and DRM_B 211, respectively. In the most simple embodiment digital rights objects in accordance with the system are just independent service keys. In a more advantageous embodiment, the digital rights object is a service key residing inside a separate trusted processing agent on the client device. Examples of suitable DRM systems include Open Mobile Alliance's OMA DRMv2 and proprietary similar systems running inside a smart-card such as the Universal Subscriber Identity Module USIM, each of which has a trusted processing agent that can extract a key from a compatible rights object.

The output of 210 and 211 are intermediate values c_{—}1 and c_{—}2, respectively. TEK, c_{—}1 and c_{—}2 are applied to a mix function 212 to generate DIFF, which is transmitted along with seed value 209 to connected receivers. In the given example mix function 212 is an XOR of TEK, c_{—}1 and c_{—}2. The mix function must be reversible such that if mix_E(TEK, c_{—}1, c_{—}2)=X, then mix_D(X, c_{—}1, c_{—}2)=TEK. Other suitable mix functions, however, are known in the art or could be devised without departing from the teachings of this disclosure. Examples of other suitable mix functions include:

(1) Lagrange interpolation in a defined finite field;

(2) group operation over all inputs in a cyclic finite Abelian group; or

(3) exponentiation of the generator of a cyclic Abelian group, where the discrete logarithm base g of TEK base is known, by generating TEK=gˆx, letting p be a large prime, letting mix_E(x, c_{—}1, . . . , c_n)=gˆ{x/(c_{—}1* . . . * c_n)}=y mod p, and letting mix_D(y, c_{—}1, . . . , c_n)=yˆ{c_{—}1* . . . * c_n} mod p.

For the connected mode, FIG. 2 shows an example that uses rights objects from two DRM models. The system, however, is not limited to just to two rights objects or two DRM systems. The disclosed system can be generalized with additional parameters c_{—}1, c_{—}2, . . . c_n added to the mix function, where the additional parameters are generated by multiple independent rights objects according to various DRM systems.

The digital rights objects required to access certain content can then be grouped into privileged sets I_{—}1, . . . I_m where each group identifies the set of digital rights object that are required simultaneously to access the content encryption key. Each such user's receiver will contain a number of DRM rights objects RO_j. The privileged sets are identified by the set of RO_j contained therein. However, a particular RO_j can only be a member of one set I_i for a given seed value. For each privileged set I_i, DIFF_i is calculated such that the parameters of the mix function used to generate DIFF_i are TEK and the intermediate values c_{—}1 . . . c_n as generated by applying the seed value to each rights object RO_j that is in set I_i. In other words, if the privileged set I_{—}1 included RO_a, RO_b, RO_c, then DIFF_{—}1=mix_E(TEK, c_{—}1=RO_a(SEED), c_{—}2=RO_b(SEED), c_{—}3=RO_c(SEED)). To activate all authorized users, the key-stream for the broadcast system would be the seed value, each privileged set I_i and their associated DIFF_i, i.e., the key-stream: SEED, I_i, DIFF_i.

In the case that the mix_E and mix_D functions are based on the XOR binary operator then TEK is decrypted linear combination of DIFF_i and a set of c_j=D_{K_j}(SEED). Even if one c_j is unknown, this linear combination contains at least two unknowns TEK and the unknown c_j. Accordingly, even if all but one DRM system RO_j is defeated, exposing all particular c_i, at least one other RO_j and its output c_j remain secure. If so, the linear combination remains unsolvable because there are always to two random unknowns. The same logic applies even if the mix_E and mix_D functions are not linear combinations. If the attacker is lacking a value c_j then the attacker will have one equation and two unknowns and as such is unable to solve the equation.

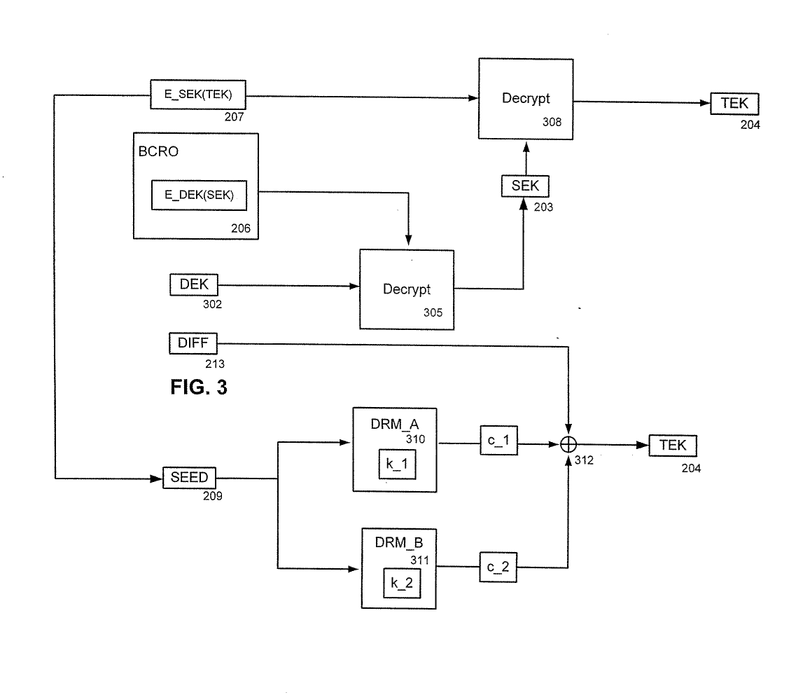

FIG. 3 shows the decryption required to obtain the value TEK after the encryption shown in FIG. 2. A non-connected mode device receives a broadcast key stream contained BCRO 206 and E_SEK(TEK) 207. The receiver generates or retrieves from storage DEK 302, which is identical to DEK 202 from FIG. 2. In accordance with the rights defined by the BCRO, the non-connected receiver decrypts 305 E_DEK(SEK) 206 with DEK 302 to generate SEK 203. SEK 203 is used to decrypt 308 E_SEK(TEK) 207 to generate TEK 204. The non-connected receiver may now use TEK to decrypt the encrypted content: D_TEK(C)=P.

The connected mode decryption for the connected mode is also shown in FIG. 3. A connected mode receiver will extract DIFF 213 and SEED 209, in this case E_SEK(TEK) 207, from the key-stream. The seed is processed by both DRM_A 310 to generate intermediate value c_{—}1 and DRM_B 311 to generate intermediate value c_{—}2. DIFF, c_{—}1 and c_{—}2 are then applied to mix_D to generated TEK 204, i.e., mix_D(DIFF, T_{—}1, T_{—}2)=TEK.

The generalized connected decryption is summarized as follows. Extract SEED from the key stream message. Extract m pairs of privileged set definitions I_i and DIFF_i. This results in the set {<I_{—}1, DIFF_{—}1>, . . . <I_m, DIFF_m>}. Compute c_{—}1=D_{K_{—}1}(SEED), . . . , c_n=D_{K_n}(SEED). For each privileged set I_i: (1) If all rights objects RO_j in I_i are available, then compute TEK, where TEK=mix_D(DIFF_I, {j\in I_i} c_j). If completed, signal that the algorithm has successfully finished. If not, try the process with another privileged set I_i. The inability to recover TEK indicates a signal failure and a required RO_j must be missing.

In a second exemplary embodiment, the non-connected mode is the same as the disclosed in the previous embodiment. The connected mode, however, differs from the first embodiment because the second embodiment allows for the privileged sets I_i where an individual rights object can appear in multiple privileged sets, i.e. overlap.

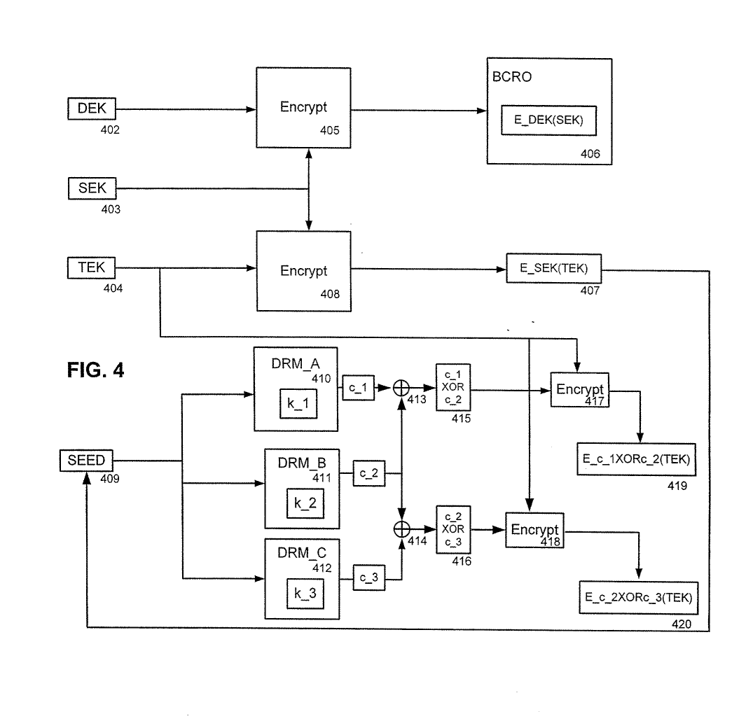

FIG. 4 shows an exemplary encryption according to the second embodiment. As noted above, the upper portion of the figure is directed to the non-connected encryption mode and is identical to the non-connected mode in the first embodiment. With respect to the connected mode, a seed value 409 is generated. As disclosed with respect to the first embodiment, the seed value can be randomly generated or could, as shown in the figure, be the result of E_SEK(TEK). The seed value 409 is applied to DRM_A 410 to generate intermediate value c_{—}1, DRM_B 411 to generate intermediate value c_{—}2, and DRM_C 412 to generate intermediate value c_{—}3.

Mix function 413 combines c_{—}1 and c_{—}2 to create c_{—}1 XOR c_{—}2 415. Mix function 414 combines c_{—}2 and c_{—}3 to create c_{—}2 XOR c_{—}3 416. The mix function disclosed in this embodiment is an XOR, but any other suitable mix function could be substituted, for example, (1) HMAC-SHA1 over constant keyed by a XOR or the concatenation of the c_j; (2) HMAC-SHA1 keyed by SEED computed over a concatenation or XOR of c_{—}1 and x; (3) any strong MAC method instead of HMAC-SHA1; (4) any PRF constrict substituted HMAC-SHA1 in any of the above; and (5) any key-wrapping method, such as AES-WRAP, keyed by XOR.

The outputs of the mix functions 415 and 416 are each used individually to encrypt TEK at 417 and 418, respectively. The encryption 417 results in E_{c_{—}1 XOR c_2}(TEK) 419, which requires the DRM_A 410 and DRM_B 411 to decrypt. The encryption 418 results in E_{c_{—}2 XOR c_{—}3}(TEK) 420, which requires DRM_B 411 and DRM_C 412 to decrypt.

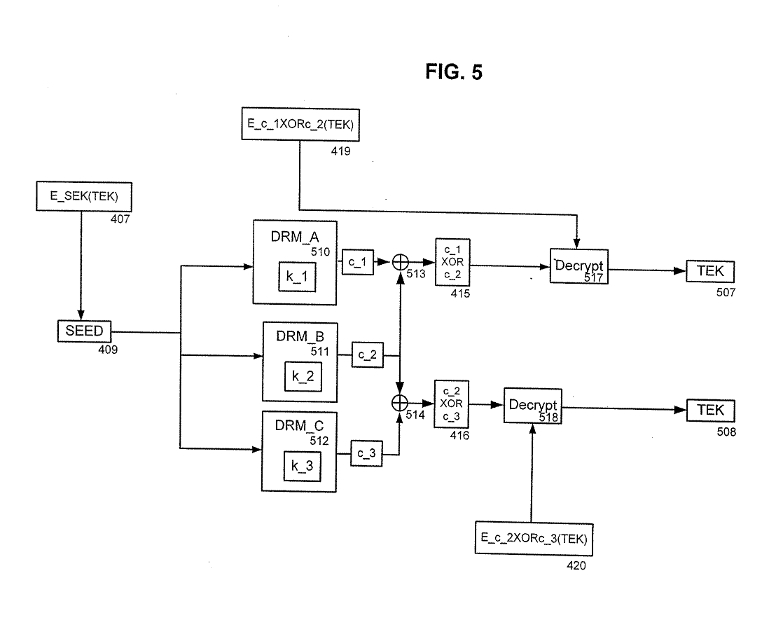

FIG. 5 shows the decryption required to discover TEK from the connected mode encryption of FIG. 4. The seed value 409 is retrieved from the key stream along with E {c_{—}1 XOR c_{—}2}(TEK) 419 and E_{c_{—}2XORc_{—}3}(TEK) 420. DRM systems 510, 511, and 512 take the seed value 409 as input to generate intermediate values c_{—}1, c_{—}2, and c_{—}3. An actual receiving device would not necessarily have all three DRM rights objects, but would encrypt over the FIG. 5 path consistent with its DRM systems it contains. Mix function 513 combines c_{—}1 and c_{—}2 to create c_{—}1 XOR c_{—}2) 415. Mix function 514 combines c_{—}2 and c_{—}3 to create c_{—}2 XOR c_{—}3 416. The outputs of the mix functions 415 and 416 are each used individually to decrypt TEK at 505 or 506, taking E_{c_{—}1 XOR c_{—}2}(TEK) 419 and E_{c_{—}2 XOR c_{—}3}(TEK) 420 respectively. The input of these encryptions are the proper secured TEK generated as disclosed in FIG. 4. Whether TEK can be decrypted at 517 or 518 depends on the rights objects available for use by the particular connected device.

The many features and advantages of the present invention are apparent from the detailed specification, and thus, it is intended by the appended claims to cover all such features and advantages of the invention which fall within the true spirit and scope of the invention.

Furthermore, since numerous modifications and variations will readily occur to those skilled in the art, it is not desired that the present invention be limited to the exact instruction and operation illustrated and described herein. Accordingly, all suitable modifications and equivalents that may be resorted to are intended to fall within the scope of the claims.

1. A method, comprising:
applying a first rights object of a privileged set of rights objects to a seed;
applying a second rights object of the privileged set of rights objects to the seed;
applying a mix function to at least an output of the application of the first rights object to the seed, an output of the application of the second rights object to the seed, and a content key; and
providing a key stream to a receiver device, wherein the key stream comprises the seed, the privileged set of rights objects, and an output of the application of the mix function.

2. The method of claim 1, further comprising:
applying a third rights object of the privileged set of rights objects to the seed,
wherein the application of the mix function comprises application of the mix function to an output of the application of the third rights object to the seed.

3. The method of claim 1, wherein the seed is one of randomly chosen and a result of encrypting the content key with a service key.

4. The method of claim 1, wherein the mix function employs one of lagrange interpolation in a defined finite field, group operation over all inputs in a cyclic finite abelian group, exponentiation of a generator of a cyclic abelian group, and exclusive or.

5. The method of claim 1, wherein the privileged set comprises rights objects required simultaneously to yield the content key.

6. A method, comprising:
applying a first rights object to a seed;
applying a second rights object to the seed;
applying a third rights object to the seed;
applying a first mix function to at least an output of the application of the first rights object to the seed and an output of the application of the second rights object to the seed;
applying a second mix function to at least the output of the application of the second rights object to the seed and an output of the application of the third rights object to the seed;
encrypting, with a content key, an output of the application of the first mix function;
encrypting, with the content key, an output of the application of the second mix function; and
providing a key stream to a receiver device, wherein the key stream comprises a result of the encryption of the output of the application of the first mix function, the seed, and a result of the encryption of the output of the application of the second mix function,
wherein a first privileged set of rights objects comprises the first rights object and the second rights object, and
wherein a second privileged set of rights objects comprises the second rights object and the third rights object.

7. The method of claim 6, further comprising:
applying a further rights object of the first privileged set of rights objects to the seed,
wherein the application of the first mix function comprises application of the first mix function to an output of the application of the further rights object to the seed.

8. The method of claim 6, wherein the seed is one of randomly chosen and a result of encrypting the content key with a service key.

9. The method of claim 6, wherein each of the first mix function and the second mix function employs one of HMAC-SHA1, strong MAC, PRF, and AES-WRAP.

10. The method of claim 6, wherein each of the first privileged set and the second privileged set comprises rights objects required simultaneously to yield the content key.

11. A method, comprising:
inserting, into a rights object, a result of encrypting a service key with a device key of a receiver device;
encrypting, with the service key, a content key; and
providing a key stream to the receiver device, wherein the key stream comprises the rights object and a result of the encryption of the content key.

12. A method, comprising:
receiving a key stream, wherein the key stream comprises a seed, a privileged set of rights objects, and an output of an application of a mix function;
applying a first rights object of the privileged set of rights objects to the seed;
applying a second rights object of the privileged set of rights objects to the seed; and
applying the mix function to at least an output of the application of the first rights object to the seed, an output of the application of the second rights object to the seed, and the received output, wherein a content key is yielded.

13. A method, comprising:
receiving a key stream, wherein the key stream comprises a result of a first encryption, a seed, and a result of a second encryption;
applying a first rights object to the seed;
applying a second rights object to the seed;
applying a mix function to at least an output of the application of the first rights object to the seed and an output of the application of the second rights object to the seed; and
decrypting, with an appropriate one of the result of the first encryption and the result of the second encryption, an output of the application of the mix function, wherein a content key is yielded,
wherein a first privileged set of rights objects comprises the first rights object and the second rights object, and
wherein a second privileged set of rights objects comprises the second rights object and a third rights object.

14. A method, comprising:
receiving a key stream, wherein the key stream comprises a rights object and a result of an encryption;
decrypting, with a device key, contents of the rights object; and
decrypting, with a result of the decryption of the contents of the rights object, the received result, wherein a content key is yielded.

15. An apparatus, comprising:
a processor;
a memory;
a transmission interface;
wherein the memory contains a program which causes the processor to:
apply a first rights object of a privileged set of rights objects to a seed;
apply a second rights object of the privileged set of rights objects to the seed;
apply a mix function to at least an output of the application of the first rights object to the seed, an output of the application of the second rights object to the seed, and a content key; and
provide a key stream to a receiver device, wherein the key stream comprises the seed, the privileged set of rights objects, and an output of the application of the mix function.

16. An apparatus, comprising:
a processor;
a memory;
a transmission interface;
wherein the memory contains a program which causes the processor to:
apply a first rights object to a seed;
apply a second rights object to the seed;
apply a third rights object to the seed;
apply a first mix function to at least an output of the application of the first rights object to the seed and an output of the application of the second rights object to the seed;
apply a second mix function to at least the output of the application of the second rights object to the seed and an output of the application of the third rights object to the seed;
encrypt, with a content key, an output of the application of the first mix function;
encrypt, with the content key, an output of the application of the second mix function; and
provide a key stream to a receiver device, wherein the key stream comprises a result of the encryption of the output of the application of the first mix function, the seed, and a result of the encryption of the output of the application of the second mix function,
wherein a first privileged set of rights objects comprises the first rights object and the second rights object, and
wherein a second privileged set of rights objects comprises the second rights object and the third rights object.

17. An apparatus, comprising:
a processor;
a memory;
a transmission interface;
wherein the memory contains a program which causes the processor to:
insert, into a rights object, a result of encrypting a service key with a device key of a receiver device;
encrypt, with the service key, a content key; and
provide a key stream to the receiver device, wherein the key stream comprises the rights object and a result of the encryption of the content key.

18. An apparatus, comprising:
a processor;
a memory;
a transmission interface;
wherein the memory contains a program which causes the processor to:
receive a key stream, wherein the key stream comprises a seed, a privileged set of rights objects, and an output of an application of a mix function;
apply a first rights object of the privileged set of rights objects to the seed;
apply a second rights object of the privileged set of rights objects to the seed; and
apply the mix function to at least an output of the application of the first rights object to the seed, an output of the application of the second rights object to the seed, and the received output, wherein a content key is yielded.

19. An apparatus, comprising:
a processor;
a memory;
a transmission interface;
wherein the memory contains a program which causes the processor to:
receive a key stream, wherein the key stream comprises a result of a first encryption, a seed, and a result of a second encryption;
apply a first rights object to the seed;
apply a second rights object to the seed;
apply a mix function to at least an output of the application of the first rights object to the seed and an output of the application of the second rights object to the seed; and
decrypt, with an appropriate one of the result of the first encryption and the result of the second encryption, an output of the application of the mix function, wherein a content key is yielded,
wherein a first privileged set of rights objects comprises the first rights object and the second rights object, and
wherein a second privileged set of rights objects comprises the second rights object and a third rights object.

20. An apparatus, comprising:
a processor;
a memory;
a transmission interface;
wherein the memory contains a program which causes the processor to:
receive a key stream, wherein the key stream comprises a rights object and a result of an encryption;
decrypt, with a device key, contents of the rights object; and
decrypt, with a result of the decryption of the contents of the rights object, the received result, wherein a content key is yielded.
